(19) United States
(12) Patent Application Publication
(10) Pub. No.: US 2007/0293602 A1
(43) Pub. Date: Dec. 20, 2007

(54) Centrifugation of Synthetic Rubber Latex

(76) Inventor: Balachandra Chakkingal Sekhar, Selangor (MY)

Correspondence Address: WELSH & KATZ, LTD, 120 S RIVERSIDE PLAZA, 22ND FLOOR, CHICAGO, IL, 60606, US

(21) Appl. No.: 10/565,461

(22) PCT Filed: Jul. 21, 2003
(86) PCT No.: PCT/SG03/00173

§ 371 Date: Apr. 9, 2007

(51) Int. Cl. C08C 1/08

(52) U.S. Cl. 523/335

(57) ABSTRACT

The present invention provides for a method of concentrating synthetic rubber latices, in particular all emulsion polymerised diene rubbers latices such as styrene-butadiene rubber (SBR) latex, neoprene latex, etc. The technique generally entails, firstly, adding creaming agents, such as tamarind seed powder or alginate (including ammonium alginate) to the synthetic rubber latex so that clustering of the latex particles may be achieved. The clustered latex particles are thus larger and is thus able to be centrifuged in the usual manner using conventional centrifuges or techniques to separate the concentrate from the skim.

### FIELD OF INVENTION

This invention is an addition and complements our co-pending Malaysian Patent Application No. PI 20014729 which discloses improvements in or relating to the concentration of natural rubber latex by centrifugation using commercially available centrifuge machines. The present invention relates to the concentration of synthetic rubber latex by centrifugation using conventional centrifuge machines.

### BACKGROUND OF INVENTION

The centrifugation process for concentration of natural rubber latex is very well known and widely practiced in all natural rubber-producing countries. In our co-pending Malaysian Patent Application No. PI 20014729, a method was described by which the efficiency of cream separation can be increased from the conventional range of 85%-89% to more than 95%, thereby significantly improving productivity, reducing costs and diminishing the quantum of low market-value skim rubber.

Conventionally, the centrifugation process is not normally applied in concentrating synthetic rubber emulsions. Instead the conventional techniques used are evaporation by heating and creaming with creaming agents. Centrifugation of synthetic emulsion polymerised latices is hampered by the small size of the latex particles of synthetic rubber. The size of the synthetic rubber particles is in the order of those obtaining in particles of natural latex skim fraction. Thus, commercially, the industry currently resorts to creaming or evaporation methods to concentrate synthetic rubber latex.

Agglomeration of the synthetic latex particles through freezing has been attempted as an alternative concentration method; however it was not found to be commercially viable.

### OBJECTS AND SUMMARY OF THE INVENTION

It is an object and purpose of the present invention to provide for a process of concentration of synthetic rubber latex using conventional centrifuge without the above-mentioned drawbacks.

In our co-pending application, the invention was applied to the centrifugation of natural rubber latex. We have now established that the process also applies to emulsion polymerised synthetic rubber latices.

To achieve the foregoing object, the present invention provides for a process of concentrating emulsion polymerised synthetic rubber lattices comprising effecting clustering of the latex particles prior to centrifugation using commercially available centrifuges. Preferably, the clustering is effected by creaming agents such as tamarind seed powder or alginates (including ammonium alginate).

In one preferred embodiment, the clustering of the synthetic latices is effected by adding from 0.05% to 1.0% on latex of the creaming agent and kept standing for 2 to 24 hours prior to centrifugation. Preferably still, the separation of cream and stabilization is further improved by the addition of a soap including ammonium oleate.

In one preferred embodiment of the process, mechanical centrifugation using commercial centrifuge means for producing synthetic rubber latex concentrates is employed.

### DETAILED DESCRIPTION OF THE INVENTION

The principle of clustering of latex particles using latex creaming agents followed by centrifugation was never conceived or tested by the synthetic latex industry. We have now established that the technique applied to natural rubber latex as disclosed in our said co-pending Malaysian patent application No. PI 20014729 can also be effectively applied to synthetic rubber latices, in particular all emulsion polymerised diene rubbers latices such as styrene-butadiene rubber (SBR) latex, neoprene latex, etc.

The technique generally entails, firstly, adding creaming agents, such as tamarind seed powder or alginate (including ammonium alginate) to the synthetic rubber latex so that clustering of the latex particles may be achieved. The clustered latex particles are thus larger and are thus able to be centrifuged in the usual manner using conventional centrifuges to separate the concentrate from the skim.

The two examples in the following illustrate the efficacy of the process.

### TREATMENT PROCEDURE FOR BOTH EXAMPLE I AND EXAMPLE II

i. SBR and neoprene latices are separately treated with 0.07% ammonium alginate or 0.16% tamarind seed powder, both in solution form and kept standing for 2 to 24 hours and then centrifuged in the usual manner.
ii. Control SBR and neoprene latices treated with the creaming agents are also kept standing for 2 to 3 weeks to allow creaming to take effect.
iii. The dry rubber content (DRC) of the centrifuged lattices after 24 hours and the creamed lattices after 3 weeks are then determined.

The tables below show the results obtained.

### Example I

### Tamarind Seed Powder as Creaming Agent (0.7% on DRC)

DRC

| Treatment | SBR | Neoprene |
|---|---|---|
| Control | 25.0 | 22.0 |
| Centrifuged after | 50.0 | 52.0 |
| clustering | | |
| Creamed at 2 weeks | 35.0 | 38.0 |

### Example II

### Ammonium Alginate as Creaming Agent (0.1% of DRC)

DRC

| Treatment | SBR | Neoprene |
|---|---|---|
| Control | 25.0 | 22.0 |
| Centrifuged after clustering | 51.0 | 51.0 |
| Centrifuged after clustering & | 53.0 | 52.0 |
| addition of 0.2% ammonium oleate | | |

From the above results it is apparent that the clustering of the synthetic latex rubber particles using tamarind seed powder or ammonium alginate prior to centrifuging is effective in concentrating SBR and neoprene latices to levels comparable to that of natural rubber latex. It is also effective with carboxylated SBR latex and nitrile (NBR) latex.

It will be apparent to a person skilled in the art that the above-described process may be adapted for other synthetic rubber latices formed of emulsion polymerised diene apart from the above two specific examples of SBR and neoprene. It may also be possible to use other suitable compounds or compositions as creaming agents apart from ammonium alginate or tamarind seed powder described above. In fact, the clustering agents used can be any product commercially used in the natural rubber latex creaming process. These and other substitutes not specifically described herein are not to be considered as departures from the present invention and shall be considered as falling within the letter and spirit of the following claims.

What we claim is:

1. A process of concentrating emulsion polymerised synthetic rubber lattices comprising effecting clustering of the latex particles prior to centrifugation using commercially available centrifuges.

2. A process described in claim 1 wherein the clustering is effected by creaming agents.

3. A process according to claim 2 wherein the creaming agents include any one of tamarind seed powder and alginates, including ammonium alginate.

4. A process according to any one of claims 1 and 2 wherein the clustering of the synthetic latices is effected by adding from 0.05% to 1.0% on latex of the creaming agent and kept standing for 2 to 24 hours prior to centrifugation.

5. A process according to any one of claims 1 to 3 wherein the separation of cream and stabilization is further improved by the addition of a soap including ammonium oleate.

6. A process according to any one of the preceding claims further comprising mechanical centrifugation using commercial centrifuge means for producing synthetic rubber latex concentrates.

7. A latex composition prepared according to a method claimed in any one of claims 1 to 5.

8. A latex concentrate obtained according to any one of claims 1 to 6.

9. A product produced from a latex concentrate according to claim 8.
